(19) United States
(12) Patent Application Publication
(10) Pub. No.: US 2026/0078500 A1
(43) Pub. Date: Mar. 19, 2026

(54) ELECTROLYTIC METHOD, ELECTROLYZER, ELECTROLYSIS SYSTEM, USE, AND FACILITY

(71) Applicant: PHLAIR GMBH, Ismaning (DE)

(72) Inventors: Paul Teufel, Munchen (DE); Jonas Futter, Munchen (DE); Malte Feucht, Munchen (DE)

(21) Appl. No.: 19/109,454

(22) PCT Filed: Sep. 8, 2023
(86) PCT No.: PCT/EP2023/074807

§ 371 Date: Mar. 6, 2025

(30) Foreign Application Priority Data
Sep. 8, 2022 (DE) 10 2022 122 837.1

(51) Int. Cl. C25B 1/50; C25B 1/01; C25B 15/08

(52) U.S. Cl. CPC C25B 1/50; C25B 1/01; C25B 15/087

(57) ABSTRACT

The invention relates to a method for obtaining carbon dioxide, having the following steps: a) carrying out an anodic oxidation of hydrogen gas, an acid oxidation product being obtained; b) reacting the acid oxidation product with an alkaline carbonate-containing aqueous solution which has a pH value of >7 to 9 in particular, an aqueous acid solution being obtained; c) removing carbon dioxide from the aqueous acid solution, carbon dioxide gas and a degassed aqueous acid solution being obtained; and d) cathodically reducing acid components of the degassed aqueous acid solution in order to obtain cathodically generated hydrogen gas, wherein an aqueous alkaline solution is additionally obtained which has a pH value of 9.4 to ≥8.

### TECHNICAL FIELD OF THE INVENTION

The present invention relates to a method for carbon dioxide extraction, especially from seawater or a gas containing carbon dioxide, especially air or a point source, an electrolyzer for carbon dioxide extraction, an electrolysis system including such an electrolyzer, a use of such an electrolyzer in a plant for electrolytic carbon dioxide extraction from seawater or a gas containing carbon dioxide, especially air or a point source, as well as a plant for electrolytic carbon dioxide extraction from seawater.

### DESCRIPTION

With the increasing concentration of carbon dioxide in the atmosphere and the resulting rise in global average temperatures, systems for extracting carbon dioxide from the atmosphere are gaining significance. Besides direct air capture (DAC) from the ambient air, there are also technical possibilities for extracting or recovering carbon dioxide from carbonate-containing aqueous solutions, particularly seawater.

Electrochemical methods can split water into basic and acidic components. In an acidic environment, the chemical equilibrium shifts from

$${CO}_{3}^{2 -} through {HCO}_{3}^{-} to {CO}_{2}^{} and {H}_{2}^{} O$$

(see equation (1) below).

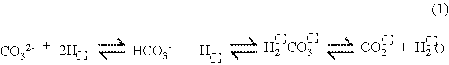

Common electrochemical methods for splitting water into acidic and basic streams generally use one or more ion-exchange membranes. These membranes selectively allow either cations (CEM) or anions (AEM) to pass through. Additionally, bipolar membranes (BPM) may be employed to separate aqueous systems into an acidic

$$( {H}_{}^{+} )$$

and a basic

$$( {OH}_{}^{-} )$$

stream.

So-called E-CEM (Electrocatalytic Cation Exchange Module) systems operate with two cation-exchange membranes between the electrodes. Here, water flows through all three separated compartments. By applying a voltage, the proton concentration in the middle compartment increases due to the migration of

$${H}_{}^{-} - ions .$$

Consequently, the pH value decreases, making it possible to extract

$${CO}_{2}^{}$$

from the solution. The energy consumption of such systems is approximately 20,000 kWh/t-CO₂.

Compared to E-CEM systems, bipolar membrane electrodialysis systems (BPMED) are more energy-efficient, requiring approximately 920 kWh/t-CO₂ or 1,400 kWh/t-CO₂ to extract CO₂ from an aqueous solution. Using a redox-active electrolyte stream that circulates directly at the cathode or anode can suppress redox reactions such as the formation of

$${H}_{2}^{} ( HER ) and {O}_{2}^{} ( OER ) from {H}_{2}^{} O .$$

Preferred electrolytes include systems with Fe(II) and Fe(III) ions, such as potassium hexacyanoferrate(II) and potassium hexacyanoferrate(III), although other compounds may also be used. At the bipolar membrane, water molecules are split into an acidic

$$( {H}_{}^{+} )$$

and a basic

$$( {OH}_{}^{-} )$$

stream. The acidic stream can be used to recover CO₂, while the basic stream is used to alkalinise the process water.

The highest energy efficiency for CO₂ recovery from aqueous systems to date according to the state of the art has been achieved using electrochemical hydrogen looping (EHL). This setup involves three compartments. The cathode compartment is flooded with seawater, producing H₂ and OH⁻ at the cathode. The resulting hydrogen is directed into the anode compartment. There, H₂ is oxidized to H⁺ and transferred to the middle compartment to acidify the incoming seawater.

Nanofiltration is typically necessary for electrochemical methods to remove or recover carbon dioxide from seawater. If high pH conditions are present in parts of the system, such as the cathode compartment, this can lead to mineral precipitation of divalent magnesium or calcium ions. These ions are essential for maintaining high seawater alkalinity and thus the ability to reabsorb atmospheric carbon dioxide. Moreover, the precipitated minerals can contaminate the system, causing issues such as electrode fouling, which would increase energy costs over time.

Nanofiltration is a highly complex and costly process, with operational costs estimated at €0.20 per cubic meter of processed water. To extract one ton of carbon dioxide from seawater with a concentration of 2.2 mM of dissolved carbon dioxide at an efficiency of 90%, one would need 11477 m³ water. This calculation results in nanofiltration costs alone of around €2,000 for extracting one tonne CO₂.

Accordingly, the present invention aims to reduce or eliminate these disadvantages.

### SUMMARY OF THE INVENTION

This objective above is achieved by the invention as defined in the independent claims.

According to a first aspect, the present invention relates to an electrolytic method, particularly a continuously operated electrolytic method, for carbon dioxide extraction comprising the following steps:
a) anodic oxidation of hydrogen gas to obtain an acidic oxidation product;
b) conversion of the acidic oxidation product with an alkaline carbonate-containing aqueous solution, which particularly has a pH of >7 to 9, to obtain an acidic aqueous solution;
c) withdrawal of carbon dioxide from the acidic aqueous solution to obtain carbon dioxide gas and a degassed acidic aqueous solution;
d) cathodic reduction of acidic components of the degassed acidic aqueous solution to obtain cathodically generated hydrogen gas and an alkaline aqueous solution with a pH of 10 to ≥7.1.

According to a second aspect, the present invention provides an electrolyzer for carbon dioxide extraction, comprising:
an anode compartment,
an intermediate compartment, and
a cathode compartment, wherein
   the intermediate compartment is arranged between the anode compartment and the cathode compartment; the anode compartment is connected to the intermediate compartment via a first transport membrane;
   the cathode compartment is connected to the intermediate compartment via a second transport membrane;
   the anode compartment and cathode compartment are fluidly connected via a hydrogen gas line;
   the intermediate compartment has an inlet and an outlet, with the outlet fluidly connected to a carbon dioxide extraction device, and the carbon dioxide extraction device directly fluidly connected to an inlet of the cathode compartment via a liquid line.

According to a third aspect, the present invention relates to an electrolysis system comprising at least one electrolyzer according to the second aspect of the present invention.

According to a fourth aspect, the present invention relates to the use of an electrolyzer according to the second aspect of the present invention in a plant for electrolytic carbon dioxide extraction from seawater.

According to a fifth aspect, the present invention relates to a plant for electrolytic carbon dioxide extraction from seawater, comprising an electrolyzer according to the second aspect of the present invention or an electrolysis system according to the third aspect of the present invention.

According to a sixth aspect, the present invention relates to the use of an electrolyzer according to the second aspect of the present invention in a plant for electrolytic carbon dioxide extraction from a gas containing carbon dioxide, particularly from air or a point source.

According to a seventh aspect, the present invention relates to a plant for electrolytic carbon dioxide extraction from a gas containing carbon dioxide, particularly from air or a point source, comprising an electrolyzer according to the second aspect of the invention or an electrolysis system according to the third aspect of the present invention.

### TECHNICAL EFFECTS OF THE INVENTION

The aspects of the invention enable significantly more energy-efficient process operations than previous methods for electrolytic carbon dioxide extraction. Additionally, these aspects reduce mineral precipitation from the carbonate-containing solution, particularly in the cathode compartment, even in the presence of divalent cations. This leads to a milder process operation, as cathode maintenance intervals are extended. This is especially due to reduced fouling of cathode materials by mitigating hydroxide precipitation of calcium and/or magnesium. At the same time, divalent cations such as Mg²⁺ and Ca²⁺ can be returned to the sea, eliminating the need for a nanofilter. This has ecological advantages by allowing further CO₂ absorption via carbonates and economic benefits by removing the requirement for an expensive and maintenance-intensive nanofilter. Furthermore, the invention allows for a pH value, e.g., around 8.1, that does not significantly deviate from seawater. This avoids discharging effluents from electrolysis into the sea with a lower pH than seawater. Thus, the present method is advantageous for the marine ecosystem in terms of pH, as it avoids ocean acidification.

Moreover, energy efficiency in carbon dioxide extraction from air can be improved with the aspects of the invention, as lower voltages can be achieved.

Further details on the technical effects achieved by the invention are found in the detailed description.

### Definitions

Unless otherwise stated, all technical terms used herein correspond to the common professional understanding.

The term “carbon dioxide extraction” is broadly understood to mean the removal of carbon dioxide in its gaseous form from a carbonate-containing aqueous solution, formally converting carbonate/bicarbonate to dihydrogen carbonate using H⁺ cations, which decomposes into water and carbon dioxide gas, as shown in equation (1) above.

The term “acidic” is broadly understood to refer to an “acidic aqueous solution” with a pH value of <7. Accordingly, “pH neutral” refers to a pH value of 7.

The term “alkaline” or “basic” is also broadly understood to refer to an “alkaline aqueous solution” with a pH value of >7.

The term “pH value” corresponds to the common skilled person's understanding and can be measured with a pH meter. The pH values disclosed herein can, for example, be measured using a VOLTCRAFT PHT-200 combined meter for pH value and redox potential (ORP). The following technical specifications for this measuring device are provided below.
Measurement range (mV): −1999 to 1999 mV
Accuracy (mV): ±0.5%

### Accuracy (pH):

$$\pm ( 0.02 pH + 2 d )$$

Automatic temperature compensation
Yes
   Operating temperature

$$0 \sim 50 °C .$$

### Resolution

0.01
   Power supply (details)
9 V

### Dimensions

$$( L \times W \times H ) 68 \times 30 \times 195 mm$$

### Weight

250 g

### Height:

195 mm

### Length:

68 mm

### Width:

30 mm

Measurement range (pH)
0-14 pH

### Calibration

Factory standard (without certificate)

### Display

Digital

### Interfaces

RS-232
   Measurement functions
pH value
Redox (ORP)
   Maximum pH measurement range
14 pH
   Minimum pH measurement range
0 pH
   Product type
Combination measuring device

The specified measuring device is factory-calibrated as standard and can additionally be calibrated with pH buffer solutions (pH=4 and pH=7) included in the delivery.

The term “acidic oxidation product” is broadly understood and, without being bound to a specific theory, refers to the formal proton product of the oxidation of diatomic hydrogen, particularly hydrogen gas. This formal proton product may exist solvated in aqueous solution as H₂O⁺_{(aq)}, with Cl⁻_{(aq)} potentially present as a counteranion, and/or as part of a solid electrode material and/or solid membrane material, enabling transport of the formal proton product via known mechanisms. In addition to chloride, other counteranions derived from acids such as H₂SO₄, HCO₃⁻, H₂CO₃, H₃BO₃, and HBr may also formally exist in all aforementioned cases.

The term “carbonate-containing aqueous solution” is broadly understood and includes carbonate in any chemical form. A “carbonate-containing aqueous solution” is typically alkaline, with a pH>7 to 9, >7 to 9.4, or >7 to 10. This means the aqueous solution contains dissolved carbonate (CO₃²⁻) and/or bicarbonate. An example of a “carbonate-containing aqueous solution” is seawater. The carbonate-containing aqueous solution particularly contains divalent cations such as magnesium, calcium, and/or strontium. Furthermore, the carbonate-containing aqueous solution may also include monovalent cations such as sodium.

The term “seawater” is used interchangeably and equivalently with “saltwater” and “saline water,” broadly referring to an aqueous solution sourced from a saline body of water, particularly a saline sea such as an ocean. Naturally, the precise chemical composition may vary depending on the location of seawater collection. For example, a composition provided by Kester, D. R., Duedall, I. W., Connors, D. N., and Pytkowicz, R. M. (1967), Preparation of Artificial Seawater Archived 2008 Dec. 17. Limnology & Oceanography, 12, 176-179), which is incorporated by reference, serves as an approximate example. From this publication, Tables 1 and 2 are provided as approximate examples of the composition of seawater.

TABLE 1
Information on the approximate composition
of seawater regarding gravimetric salts.
Gravimetric salts

| | Molecular | g kg⁻¹ |
|---|---|---|
| Salt | weight | solution |
| Sodium chloride | 58.44 | 23.926 |
| (NaCl) | | |
| Sodium sulphate | 142.04 | 4.008 |
| (Na₂SO₄) | | |
| Potassium sulphate | 74.56 | 0.677 |
| (KCl) | | |
| Sodium bicarbonate | 84.00 | 0.196 |
| (NaHCO₃) | | |
| Potassium bromide | 119.01 | 0.098 |
| (KBr) | | |
| Boric acid | 61.83 | 0.026 |
| (H₃BO₃) | | |
| Sodium fluoride | 41.99 | 0.003 |
| (NaF) | | |

TABLE 2
Information on the approximate composition
of seawater regarding volumetric salts.
Volumetric salts

| | Molecular | mol kg⁻¹ |
|---|---|---|
| Salt | weight | solution |
| Magnesium chloride | 203.33 | 0.05327 |
| (MgCl₂•6H₂O) | | |
| Calcium chloride | 147.03 | 0.01033 |
| (CaCl₂•2H₂O) | | |
| Strontium chloride | 266.64 | 0.00009 |
| (SrCl₂•6H₂O) | | |

The term “degassed acidic aqueous solution” refers broadly to an aqueous solution with a pH<7 from which carbon dioxide gas has been essentially entirely removed. Such a degassed acidic solution may be obtained by extracting carbon dioxide gas, e.g., via a membrane contactor, from an acidic aqueous solution. This degassed acidic aqueous solution particularly retains divalent cations such as magnesium and/or calcium. Specifically, the degassed acidic aqueous solution contains ≤10 wt %, preferably ≤5 wt %, carbon dioxide, where the percentage by mass is based on the original mass of carbon dioxide present as carbonate and/or bicarbonate in the alkaline carbonate-containing aqueous solution. In other words, the separation efficiency is at least 90%, preferably at least 95%.

The term “acidic components” generally refers to protons in their aqueous form, i.e., H₃O⁺_{(aq)}.

The term “fluidly connected” is broadly understood, referring particularly to a connection, such as a pipeline, between two electrolysis units designed to transport a fluid, such as a liquid or a gas like hydrogen gas, from one electrolysis unit to another. Such an electrolysis unit may include a cathode compartment, an anode compartment, or an intermediate compartment located between the anode and cathode compartments.

The term “gas containing carbon dioxide” is broadly understood. Particularly, such a gas may include air. A skilled person is familiar with the composition of air at a given location or knows methods to measure this composition. Additionally, a “gas containing carbon dioxide” may also originate from a point source. A point source is typically an industrial source of CO₂ where the process generates more carbon dioxide gas than is normally present in air. Examples include flue gases from industrial processes such as cement production and/or coal combustion. A point source may contain gas with a carbon dioxide content of approximately 10 mol % to 25 mol %, particularly 14 mol % to 21 mol %, based on the total volume of the humid gas. Such a gas may also have a carbon dioxide content of about 10 vol % to 20 vol %. Overall, the mass/volume/molar fraction of carbon dioxide in a gas containing carbon dioxide is fundamentally non-critical to the function of the present invention and its aspects.

A sample process for capturing carbon dioxide from a gas containing carbon dioxide is exemplified in FIG. 4. Various technical configurations may be considered for CO₂ absorption. For example, for low CO₂ concentrations such as in air, it may be advantageous to expose the gas to the alkaline solvent using a crossflow method with a cooling tower-like structure. For higher CO₂ concentrations, such as in flue gas from industrial processes, a column that contacts the gas and the aqueous alkaline solution using a counterflow principle may be technically and economically more suitable. Furthermore, the carbonate-containing aqueous solution may also include monovalent cations such as sodium. A carbonate-containing aqueous solution may specifically or exclusively contain monovalent cations such as sodium or potassium. These monovalent cations may, for example, be paired with counteranions selected from the group consisting of sulphate, perchlorate, nitrate, iodide, or combinations thereof. Specifically, dissolved salts may be selected from the group consisting of Na₂SO₄, K₂SO₄, NaClO₄, KClO₄, NaNO₃, KNO₃, NaI, KI. The term “alkaline carbonate-containing aqueous solution” is used equivalently to “carbonate-containing aqueous solution.”

### BRIEF DESCRIPTION OF THE DRAWINGS:

FIG. 1 shows an embodiment of an electrolyzer according to the invention.

FIG. 2 shows an embodiment of an electrolysis system according to the invention with a monopolar configuration.

FIG. 3 illustrates an exemplary Pourbaix diagram of water.

FIG. 4 shows an embodiment of the electrolysis system according to the invention for extracting carbon dioxide from a gas containing carbon dioxide.

FIG. 5 shows an embodiment of the electrolysis system according to the invention with a bipolar configuration.

### DETAILED DESCRIPTION

The embodiments shown below illustrate advantageous configurations of the present invention, which should not be understood as limiting the scope of the invention. Features of the various embodiments within the different aspects of the invention may be freely combined unless otherwise stated.

### Electrolytic Method

According to a first aspect, the present invention relates to an electrolytic method, particularly a continuously operated electrolytic method, for carbon dioxide extraction comprising the following steps:
a) anodic oxidation of hydrogen gas to obtain an acidic oxidation product;
b) withdrawal of the acidic oxidation product with an alkaline carbonate-containing aqueous solution, such as seawater, which particularly has a pH>7 to 9, to obtain an acidic aqueous solution;
c) extraction of carbon dioxide from the acidic aqueous solution to obtain carbon dioxide gas and a degassed acidic aqueous solution;
d) cathodic reduction of acidic components of the degassed acidic aqueous solution, wherein an alkaline aqueous solution is further obtained, wherein an alkaline aqueous solution which has a pH of 10 to ≥7.1 or 9.4 to ≥8 is further obtained. In particular, the pH value may range from 9.2 to ≥8, specifically 8.5 to ≥8, Optionally from 8.8 to ≥7.1, or further optionally from 8.0 to ≥7.1. A range of 8.4 to ≥7.1 is also possible. The pH value is measured at the cathode compartment outlet using the disclosed methods.

Anodic oxidation of hydrogen gas in step a) may occur in an aqueous solution or via a gas diffusion electrode, e.g., a zero-gap electrode. The acidic oxidation product formally corresponds to H⁺ in the following equation (2):

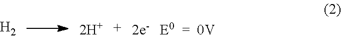

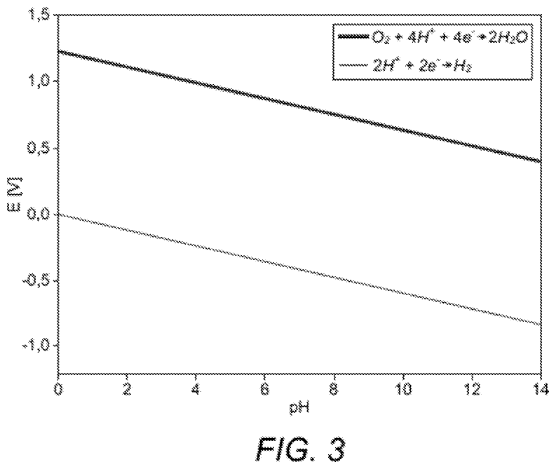

H⁺ may exist in aqueous solution as H₃O⁺_{(aq)} or as part of a solid electrode and/or membrane material. The exact form of the acidic oxidation product (H⁺) is non-critical as long as it is available for step b). In certain embodiments, hydrogen gas in step a) may be oxidized at a gas diffusion electrode without using an aqueous solution, requiring only minimal humidification of the hydrogen gas. Oxidizing hydrogen gas reduces the energy demand within the method, as oxygen generation is unnecessary. As shown in FIG. 3, the redox potential of hydrogen oxidation is significantly lower than that of water oxidation to generate oxygen.

Using the acidic oxidation product, step b) involves the conversion of a carbonate-containing aqueous solution. For instance, the oxidation product from step a) may be produced in an anode compartment, while the reaction in step b) occurs in an intermediate compartment of the electrolyzer, that can be arranged between the cathode and anode compartments. The acidic oxidation product may be brought into contact with the carbonate-containing aqueous solution via a transport membrane for the conversion. Preferably, the carbonate-containing aqueous solution has a pH of about ≥8 to about 8.5. The conversion in step b) particularly involves a chemical reaction as described in equation (1), forming dissolved carbon dioxide. Due to the conversion using the acidic oxidation product, dissolved carbon dioxide is present after the conversion in step b). In the subsequent step c), carbon dioxide gas is removed, particularly via a membrane contactor that may be arranged outside the intermediate compartment and downstream of step c). Thus, carbon dioxide is withdrawn from the acidic aqueous solution to obtain a degassed acidic aqueous solution with a pH<7. In step d), which occurs particularly in the cathode compartment, acidic components such as H⁺_{(aq)} in the degassed acidic aqueous solution and water are reduced, wherein hydrogen gas and hydroxide ions are generated, producing an alkaline aqueous solution with a pH of approximately 10 to ≥7.1 or 9.4 to ≥8, or within one of the aforementioned ranges. In particular, the alkaline aqueous solution has a pH of approximately >7.1 to 9 or 8 to 9, preferably >7.1 to 8.5 or 8 to 8.5, such as approximately 8.1. These reactions formally proceed according to the equations (3) and (4) below:

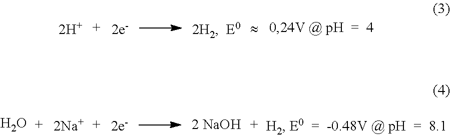

The method according to the first aspect of the invention can be operated with a direct current voltage of <1.5 V, particularly ≤1.3 V. In this context, the sodium cations in equation (4) are particularly transported from the intermediate compartment to the cathode compartment, e.g., via a transport membrane. The reactions described in equations (3) and (4) in step d) lead to the following significant technical advantages of the present invention.

Achieving a pH range of 10 to >7.1 or 9.4 to ≥8—or one of the aforementioned ranges—in the alkaline aqueous solution in step d) reduces the tendency for divalent cations, such as magnesium and/or calcium, which are particularly present in the carbonate-containing aqueous solution, to precipitate as solid hydroxides. This pH range is enabled by the presence of the degassed acidic aqueous solution in step d). In particular, the degassed acidic aqueous solution, as explained above, may include divalent cations such as magnesium and/or calcium. Through the reduction reaction in equation (3) and further water reduction in equation (4), the alkaline aqueous solution with a pH of 9.4 to ≥7 is obtained. Outside this range, the pH would be too high, leading to unfavorable precipitation of said hydroxides, which causes the significant fouling of the cathode discussed earlier. By reducing hydroxide precipitation, divalent cations such as calcium, magnesium, and/or strontium can remain in the carbonate-containing aqueous solution without requiring a costly and maintenance-intensive nanofilter for their removal. Reducing or avoiding impurities caused by precipitated hydroxides also improves efficiency, as such impurities typically result in reduced energy efficiency. Excessive hydroxide precipitation would lower the pH of the alkaline aqueous solution, which is undesirable.

Reintroducing the alkaline aqueous solution into saline water, such as the sea, is advantageous because the presence of divalent cations allows further carbon dioxide binding. Thus, the achieved pH level also has ecological benefits. Another ecological advantage is that no acidic wastewater needs to be discharged into the saline water, such as the sea; instead, the alkaline aqueous solution has an environmentally friendly pH value. A low pH in seawater would also lead to the release of CO₂ into the atmosphere.

Surprisingly, it was also found that the partially acidic environment caused by introducing a degassed acidic aqueous solution (see equation (2) above) at the cathode results in more energy-efficient hydrogen gas generation due to kinetic and thermodynamic advantages.

Before introducing the carbonate-containing aqueous solution in step b), nitrogen and oxygen gases can be removed from the solution. This is possible, for instance, using a membrane contactor.

The electrolytic method according to the first aspect can be conducted using an electrolyzer as described in the second aspect of the present invention. The method can also be used for carbon dioxide extraction from a gas containing carbon dioxide, such as air or a point source.

In certain embodiments, the hydrogen gas produced cathodically in step d) is transferred and oxidized in step a). In other words, the method includes a hydrogen cycle (oxidation in step a), reduction in step b), re-oxidation in step d)). Thus, the invention can largely generate hydrogen autonomously, reducing the need for an external hydrogen supply. Since hydrogen production is typically energy-intensive, the hydrogen cycle represents significant efficiency savings.

In certain embodiments, the acidic oxidation product from step a) is transported for conversion in step b) via a first transport membrane, which contacts the alkaline carbonate-containing solution at the point where the acidic oxidation product exits. For example, the first transport membrane may include a gas diffusion electrode, a gas diffusion layer (GDL), and/or a zero-gap membrane electrode (CEM). A gas diffusion layer may also be considered part of the first transport membrane. In particular, the first transport membrane may comprise a perfluorosulphonic acid membrane. Preferably, such a transport membrane is based on a perfluorosulphonic acid/polytetrafluoroethylene copolymer. Materials for transport membranes can further or alternatively be selected in particular from the group consisting of: PTFE/PTFE (polytetrafluoroethylene/Teflon) based membranes, hydrocarbon membranes, sPPS (sulfonated polyphenylene sulfone) membranes. Examples include membranes known under the names Nafion, Gore, Fumasep, Fumapem, Aquivion, and/or Xion, with Nafion or Gore-Select membranes being preferred. Particularly, the acidic oxidation product can be produced in the anode compartment in step a) and diffuse through the first transport membrane, with the reaction in step b) occurring in the intermediate compartment.

In certain embodiments, metal cations, such as sodium cations, are transferred from the carbonate-containing aqueous solution during the reaction via a second transport membrane to the cathodic reduction step d). The second transport membrane may have the same features as the first transport membrane described above. Specifically, sodium cations from the carbonate-containing aqueous solution may be transported from the intermediate compartment via the second transport membrane to the cathode compartment for step d). These cations serve to balance the charge formally, as described in equation (4).

In certain embodiments, the pH of the degassed acidic aqueous solution is <5. Specifically, this pH may range from approximately 2 to <5, preferably 3 to approximately 4.5. This pH can be achieved through anodic oxidation in step 1. The acidic pH offers the aforementioned advantages.

According to certain embodiments, the degassed acidic aqueous solution in step d) may also contact an alkaline aqueous solution. For example, due to the reduction described in equation (4), an alkaline aqueous solution may accumulate in the cathode compartment over time, creating a pH gradient since the degassed acidic aqueous solution at the inlet is acidic.

### Electrolyzer for Carbon Dioxide Extraction

According to a second aspect, the present invention relates to an electrolyzer for carbon dioxide extraction, comprising:
an anode compartment,
an intermediate compartment, and
a cathode compartment, wherein
   the intermediate compartment is located between the anode compartment and the cathode compartment; the anode compartment is connected to the intermediate compartment via a first transport membrane;
   the cathode compartment is connected to the intermediate compartment via a second transport membrane;
   the anode and cathode compartments are fluidly connected via a hydrogen gas line;
   the intermediate compartment has an inlet and an outlet, with the outlet fluidly connected to a carbon dioxide extraction device, and the carbon dioxide extraction device directly fluidly connected to an inlet of the cathode compartment via a liquid line.

Naturally, the electrolyzer encompasses the features and technical effects of the electrolytic method equally. Specifically, the electrolyzer according to the second aspect of the present invention is designed to perform the electrolytic method described in the first aspect of the present invention. Accordingly, the electrolyzer can also be employed for carbon dioxide extraction from seawater.

Additionally, the electrolyzer can be used in a method for carbon dioxide extraction from a gas containing carbon dioxide, such as air or a point source. In this case, a solvent-air contactor as described herein may be used.

Specifically, the anode compartment is configured to carry out step a) of the method according to the first aspect of the present invention. Furthermore, the intermediate compartment is specifically configured to carry out step b) of the method according to the first aspect of the present invention. Accordingly, the cathode compartment is configured to carry out step d) of the method according to the first aspect of the present invention. Additionally, the carbon dioxide extraction device is configured to carry out step c) of the method according to the first aspect of the present invention.

In certain embodiments, the carbon dioxide extraction device is selected from the group consisting of membrane contactors, preferably 3M Liqui-Cel, heat exchangers, and combinations thereof. Preferably, a membrane contactor is used. In the case of a heat exchanger, it is configured to heat the acidic aqueous solution to enable the degassing of carbon dioxide gas.

Specifically, the first transport membrane is an ion transport membrane configured to transfer the acidic oxidation product from the anode compartment to the cathode compartment. Additionally or alternatively, the second transport membrane may be configured as an ion transport membrane designed to transfer monovalent cations, such as sodium cations, from the intermediate compartment to the cathode compartment.

As is apparent from the previous explanations in the description, the electrolyzer does not include a nanofilter.

Furthermore, particularly no additional operations are performed between the outlet of the intermediate compartment and the inlet of the cathode compartment, except for carbon dioxide extraction. Specifically, the fluidic connection between the outlet of the intermediate compartment and the inlet of the cathode compartment does not include any further mixing devices, ensuring the pH of the acidic aqueous solution and the degassed acidic aqueous solution remains essentially constant.

In certain embodiments, the anode compartment includes an anode material in direct contact with the first transport membrane. The anode active material is specifically selected from the group consisting of platinum, nickel/iron, nickel/cobalt, nickel, cobalt/platinum, stainless steel, iridium, iridium oxide, ruthenium, ruthenium oxide, palladium, and combinations thereof. Preferably, the anode active material is platinum. The anode material may be configured as a zero-gap electrode, with no gap present between the anode material and the first transport membrane. Furthermore, the anode material may be applied to carriers. Such carriers may be selected from the group consisting of iron, steel, titanium, carbon paper, or combinations thereof. Alternatively, the anode may be configured as a gas diffusion electrode. The gas diffusion electrode may, for example, include product variants from the Gore-Primea series.

In certain embodiments, a device for removing oxygen and nitrogen from the alkaline carbonate-containing aqueous solution may be provided before the inlet of the intermediate compartment. Such a device may be configured similarly to the carbon dioxide extraction device.

In certain embodiments, the anode compartment may include an external supply for hydrogen gas. This allows compensation for any hydrogen deficits that may arise during hydrogen recycling.

In certain embodiments, the cathode compartment may have a side opposite the second transport membrane, with the cathode compartment inlet positioned closer to this opposite side than to the second transport membrane. This may lead to the alkalization of the aqueous solution in the cathode compartment, creating a high pH gradient between the cathode and the second transport membrane. As a result, the transport of cations into the cathode compartment is significantly improved.

In certain embodiments, the inlet of the cathode compartment and the inlet of the intermediate compartment may be arranged such that the liquid flow entering the cathode compartment runs in counterflow or parallel flow to the liquid flow entering the intermediate compartment through the electrolyzer. Counterflow arrangements, in particular, have the advantage of maintaining the same pH gradient direction, encouraging positively charged cations to move into the cathode compartment.

In certain embodiments, the cathode compartment includes a cathode material, preferably selected from the group consisting of platinum, nickel, titanium, carbon paper, or combinations thereof. Platinum is specifically preferred as the cathode active material. Carbon paper with an applied Pt/C catalyst is particularly preferred.

In certain embodiments, the method according to the first aspect of the invention is conducted at a total pressure above atmospheric pressure, particularly between 2 bar and 50 bar.

The electrolyzer according to the first aspect of the present invention can be operated at temperatures below 100° C. Specifically, the electrolyzer may be operated at 60 to 80° C. Additionally, it may be possible to operate the electrolyzer at a temperature of at least 95° C. but below 100° C.

### Electrolysis System

According to a third aspect, the present invention relates to an electrolysis system comprising at least one electrolyzer according to the second aspect of the present invention.

Naturally, such an electrolysis system is designed to perform the method according to the first aspect of the present invention. The electrolysis system accordingly includes the method steps of the first aspect of the invention, along with the corresponding technical advantages. The same applies to the electrolyzer according to the first aspect of the invention.

For example, multiple electrolyzers can be used together within the electrolysis system. These electrolyzers may be connected in a stacked configuration. For instance, two electrolyzers may share a common anode compartment. Another electrolyzer may be linked to these two electrolyzers via a shared cathode. Yet another electrolyzer may be connected via a shared anode compartment, and so on.

### Use of the Electrolyzer

According to a fourth aspect, the present invention relates to the use of an electrolyzer according to the second aspect of the present invention in a plant for electrolytic carbon dioxide extraction from seawater.

According to a sixth aspect, the present invention relates to the use of an electrolyzer according to the second aspect of the present invention in a plant for electrolytic carbon dioxide extraction from a gas containing carbon dioxide, particularly from air or a point source. In this case, a solvent-air contactor as described herein may be used.

The use according to the fourth and sixth aspects includes the technical features, effects, and advantages of the method described in the first aspect and the electrolyzer described in the second aspect.

### Plant for Electrolytic Carbon Dioxide Extraction From Seawater or a Gas Containing Carbon Dioxide

According to a fifth aspect, the present invention relates to a plant for electrolytic carbon dioxide extraction from seawater, comprising an electrolyzer according to the second aspect of the present invention or an electrolysis system according to the third aspect of the present invention.

Such a plant may be positioned at a saline body of water, such as the sea. This plant may also operate using seawater as the carbonate-containing solution.

According to a seventh aspect, the present invention relates to a plant for electrolytic carbon dioxide extraction from a gas containing carbon dioxide, particularly from air or a point source, comprising an electrolyzer according to the second aspect of the invention or an electrolysis system according to the third aspect of the present invention. In this case, a solvent-air contactor as described herein may be used.

Additionally, the plant according to the fifth or seventh aspect may also be operated with the method according to the first aspect of the present invention. To avoid repetition, it is noted that the plant includes the features, technical advantages, and effects described in the first, second, third, and fourth aspects of the invention.

### Description of the Drawings

The following figures show exemplary embodiments of the present invention and should not be considered limiting.

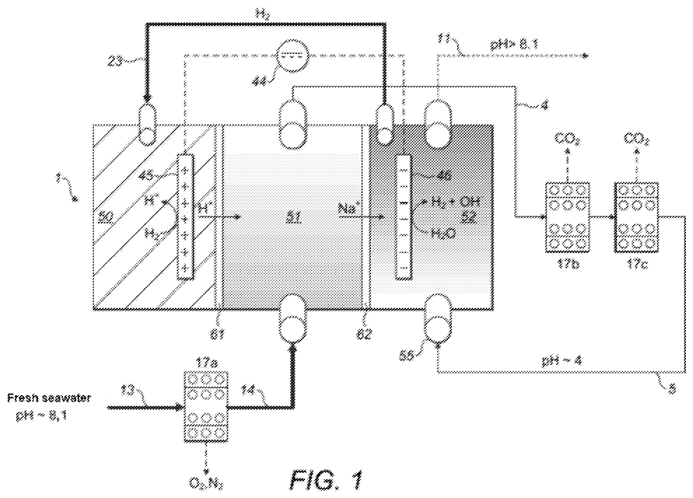

FIG. 1 shows an exemplary embodiment of an electrolyzer 1 according to the second aspect of the present invention for extracting carbon dioxide from seawater. Fresh alkaline seawater with a pH of approximately 8.1 is introduced into a first membrane contactor 17a via a first inlet line 13, which removes oxygen and nitrogen from the seawater. The alkaline seawater is introduced into an intermediate compartment 51 via a second inlet line 14, the intermediate compartment 51 being arranged between an anode compartment 50 containing an anode 45 and a cathode compartment 52 containing a cathode 46. The anode compartment 50 and the intermediate compartment 51 are separated by a first ion transport membrane 61, configured to transport protons from the anode compartment 50 to the intermediate compartment 51. The intermediate compartment 51 and the cathode compartment 52 are separated by a second ion transport membrane 62, configured to transport sodium ions from the intermediate compartment 51 to the cathode compartment 52. These electrochemical reactions are powered by an alternating voltage source 44. Within the anode compartment 50, hydrogen gas is oxidized at the anode 45 to produce an acidic oxidation product. This acidic oxidation product is transferred into the intermediate compartment 51 via the first ion transport membrane 61, where it reacts with the seawater to form an acidic aqueous solution. Hydrogen gas for the oxidation is transported, for example, from the cathode compartment 52, where it is generated at the cathode 46, to the anode compartment 50 via a hydrogen line 23. The acidic aqueous solution formed in the intermediate compartment contains dissolved carbon dioxide, produced according to equation (1). The acidic aqueous solution (with a pH of about 4) is directed through a first outlet line 4 to second and third membrane contactors 17b, 17c, where carbon dioxide gas is removed. A degassed acidic aqueous solution (with a pH of about 4) is then transferred via a second outlet line 5 into the cathode compartment 52. Within the cathode compartment, a pH gradient is present (lighter shades represent lower pH and darker shades represent higher pH). This gradient arises as the degassed acidic aqueous solution is introduced at the cathode inlet 55, while hydroxide ions are produced at the cathode 46. Depending on its flow path within the cathode compartment 52, the degassed acidic aqueous solution is neutralized by the hydroxide ions. Additionally, the pH increases as formal protons are consumed during the formation of hydrogen gas according to equation (3). Thus, an alkaline aqueous solution with a pH>8.1 is formed within the cathode compartment, which can be returned to the sea via a seawater outlet line 11.

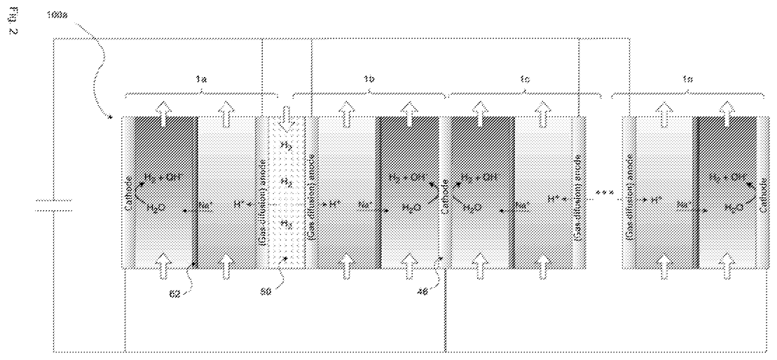

FIG. 2 depicts an example of a monopolar configuration of an electrolysis system 100a according to the third aspect of the present invention. Arrows indicate material inputs and outputs, as shown in FIG. 1. Only components relevant to this discussion are labeled with reference numbers. In this configuration, a first electrolyzer 1a and a second electrolyzer 1b are connected via their anode compartments 50. Furthermore, a third electrolyzer 1c is connected to the second electrolyzer 1b via the cathode 46. An additional electrolyzer 1n can be connected to the third electrolyzer 1c via a shared anode compartment 50, as indicated by the ellipsis in FIG. 2, and so forth.

FIG. 3 shows a Pourbaix diagram for water for illustrative purposes.

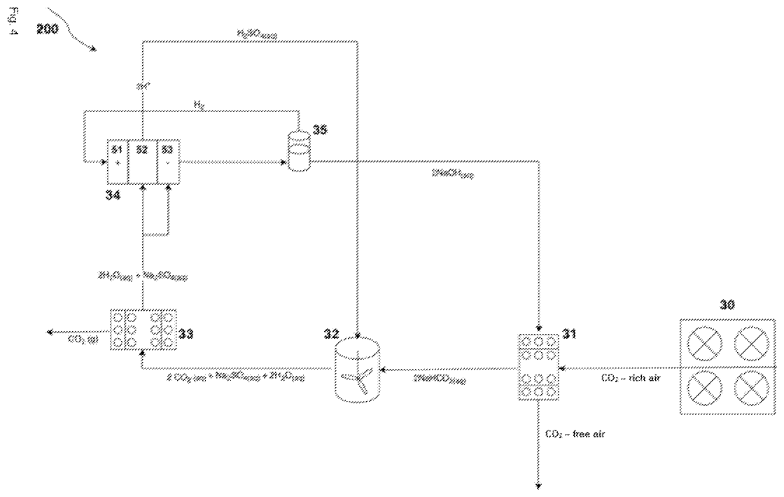

FIG. 4 illustrates an example of a plant 200 according to the third aspect of the invention, capable of performing the method described in the first aspect. A gas, such as air, is introduced into the plant 200 via an air supply system 30, which may pass through an air-liquid contactor 31, where it is absorbed into an alkaline aqueous solution. The resulting carbonate-containing aqueous solution is then mixed with an acidic aqueous solution in a mixing vessel 32 so that, for example, carbon dioxide gas can be removed from the system via one or more membrane contactors 33. The degassed acidic solution is then directed in two portions to an electrolyzer 34 according to the second aspect of the invention. The first portion of the degassed acidic solution is directed into an intermediate compartment 52, where it reacts with an acidic oxidation product from the anode compartment 51. The second portion of the degassed acidic aqueous solution is directed into the cathode compartment 53, where it undergoes reduction to produce an alkaline aqueous solution. Subsequently, the hydrogen gas can be separated from the alkaline aqueous solution in a gas-water separator 35, wherein the hydrogen can be fed to the anode compartment 51, where it is oxidized into protons according to the above reaction equation, which are fed to the intermediate compartment 52 via the first ion transport membrane 61, for example.

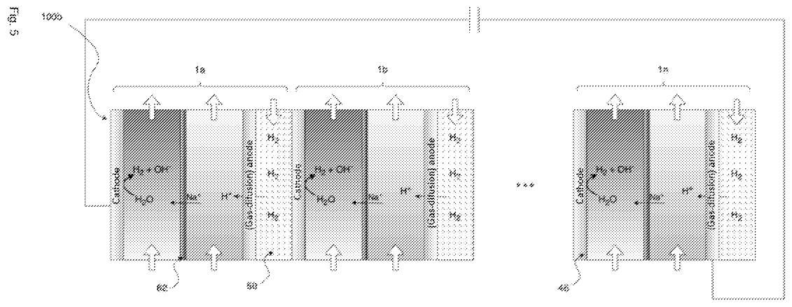

FIG. 5 depicts an example of a bipolar configuration of an electrolysis system 100b according to the third aspect of the present invention. Arrows indicate material inputs and outputs, as shown in FIG. 1. Only components relevant to this discussion are labeled with reference numbers. In this configuration, a first electrolyzer 1a and a second electrolyzer 1b are connected via their anode compartments 50. According to the aforementioned stacking technique, another electrolyzer 1n can in turn be linked to an adjacent electrolyzer via an anode compartment 50, which is indicated by the three dots in FIG. 2, etc.

### EXAMPLES

### Experimental Setup

The experiments were conducted in a plant that corresponds to the configuration shown in FIG. 4. The electrolyzer used in the experiments, as described in the second aspect of the invention, consisted of an electrolysis cell comprising two steel end plates, a graphite current collector with an integrated flow field on the anode side, and a titanium mesh current collector on the cathode side. The flow field for the intermediate compartment, with a thickness of 1 mm, was made of PTFE. Seals were made using gaskets of PTFE and FKM. Two Nafion cation exchange membranes were used. A carbon fibre diffusion medium was employed as the diffusion medium for both electrodes. Platinum on carbon was used as the catalyst for both electrodes, wherein the catalyst was applied to the gas diffusion medium on the anode side, and directly onto the membrane on the cathode side using the decal method.

The electrolyte used for the experiments was a 0.5 M sodium chloride solution in distilled water with a conductivity of 30 mS/cm.

A potentiostat/galvanostat of the model Zennium Pro by Zahner Elektrik was used for power supply and measurement.

A peristaltic pump, Shenchen LabN6III with two pump heads, was used to circulate the liquid. The electrolyte flow rate was set at 80 mL/min. In addition to the hydrogen gas separated using the gas-liquid separator, the external hydrogen supply was regulated via a Bronkhorst mass flow controller, model F201-CV.

### Experiment Description

The electrolysis cell was assembled with two graphite flow fields on both the anode and cathode sides. Two types of FKM-based gaskets, with thicknesses of 0.2 mm and 0.3 mm respectively, were used. The 0.3 mm thick gaskets were placed between the graphite flow fields and the membranes. The thinner 0.2 mm gaskets were placed between the membrane and the intermediate compartment flow field.

The flow rate was kept constant at 80 mL/min for all experiments. The active cell area was 10.2 cm², and the applied current varied between 0.02 A, 0.05 A, and 0.1 A during the experiments.

### Different Fluid Flow Configurations

Two experimental series were conducted, each differing only in the fluid flow configuration. In the first experiment, the cathode compartment and the intermediate compartment were fed from the same tank containing the 0.5 M electrolyte in deionized water. The electrolyte had a pH of 7.3 before being introduced into the cell.

In the second experiment, the outlet of the intermediate compartment was fluidly connected to the inlet of the cathode compartment. As a result, the pH at the outlet of the intermediate compartment matched the pH at the inlet of the cathode compartment, which was the main difference from the first experiment.

### Results

The experiments conducted according to the invention measured the voltages for the varied applied currents, as described above. The experimental results for introducing the same solution with a slightly basic pH into both the intermediate and cathode compartments are presented in Table 3. Table 4 shows the measured values for the system according to the present invention. In this case, the pH at the outlet of the intermediate compartment is identical to the pH at the inlet of the cathode compartment, denoted as pH_{intermediate,OUT}=pH_{Cathode,IN}.

TABLE 3
Measured cell voltages and pH values with the introduction of
identical solutions, where the pH at the inlet of both the cathode
compartment and the intermediate compartment is the same.

| Current | | | | | |
|---|---|---|---|---|---|
| density | | Experiment | Voltage | pH_{Intermediate, OUT} | pH_{Cathode, OUT} |
| 25 | mA/cm² | According to | 0.55 V | 5.7 | 8.6 |
| | | the invention | | | |
| | | L. Yan et al. | 0.62 V | 6.6 | 9.2 |
| 5 | mA/cm² | According to | 0.66 V | 5.4 | 8.8 |
| | | the invention | | | |
| | | L. Yan et al. | 0.74 V | 5.7 | 9.7 |
| 10 | mA/cm² | According to | 0.80 V | 4.1 | 10 |
| | | the invention | | | |
| | | L. Yan et al. | 0.88 V | 2.5 | 11 |

Comparative example determined according to the experimental setup and procedure described in L. Yan et al., ACS Energy Lett. 2022, 7, 1947-1952.

TABLE 4
Measured pH values at the inlets and outlets of the intermediate
and cathode compartments according to the present invention.

| | | | |
|---|---|---|---|
| Current | | | |
| density | Voltage | pH_{Cathode, IN} | pH_{Cathode, OUT} |

| | | | | |
|---|---|---|---|---|
| 25 | mA/cm² | 0.48 V | 5.7 | 7.1 |
| 5 | mA/cm² | 0.57 V | 5.3 | 7.3 |
| 10 | mA/cm² | 0.69 V | 4.0 | 7.9 |

The results in Table 3 show qualitative agreement with the comparative example. The difference in the magnitude of the pH swing might be attributed to the lower flow rate of 40 mL/min in the comparative example. In both cases, pH values greater than 10 were observed at a current density of only 10 mA/cm², This would indicate a significant likelihood of divalent ion precipitation. Surprisingly, Table 4 demonstrates that rerouting the acidic solution into the cathode compartment, as per the invention, significantly reduces the pH. This reduction ensures that mineral precipitation of divalent cations, such as Ca²⁺ or Mg²⁺, can be avoided. Another notable observation is that the measured cell voltage for all three current densities was significantly lower than in the comparative experiments, indicating that the method can be operated much more energy-efficiently.

### LIST OF REFERENCE SYMBOLS

1 Electrolyzer
1a First electrolyzer
1b Second electrolyzer
1c Third electrolyzer
1n Additional electrolyzer
11 Seawater outlet line
13 First inlet line
14 Second inlet line
17a First membrane contactor
17b Second membrane contactor
17c Third membrane contactor
23 Hydrogen line
30 Air supply
31 Air-solvent contactor
32 Mixing tank
33 Desorption device
34 Electrolyzer
35 Gas-liquid separator
44 DC power source
45 Anode
46 Cathode
50 Anode compartment
51 Intermediate compartment
52 Cathode compartment
55 Cathode inlet
61 First ion transport membrane
62 Second ion transport membrane
100a Electrolysis system with monopolar configuration
100b Electrolysis system with bipolar configuration
200 plant for direct air capture

1. Electrolytic method for carbon dioxide extraction, comprising the following steps:
a) anodic oxidation of hydrogen gas to obtain an acidic oxidation product;
b) conversion of the acidic oxidation product with an alkaline carbonate-containing aqueous solution, which particularly has a pH of >7 to 9, to obtain an acidic aqueous solution;
c) withdrawal of carbon dioxide from the acidic aqueous solution to obtain carbon dioxide gas and a degassed acidic aqueous solution;
d) cathodic reduction of acidic components of the degassed acidic aqueous solution to generate cathodically produced hydrogen gas, while also producing an alkaline aqueous solution with a pH of 10 to ≥7.1 or 9.4 to ≥8.

2-19. (canceled)
